(19) United States
(12) Patent Application Publication
(10) Pub. No.: US 2008/0103713 A1
(43) Pub. Date: May 1, 2008

(54) Labeling Asymmetric Cables For Improved Network Clock Synchronization

(76) Inventors: Lee A. Barford, San Jose, CA (US); Bruce Hamilton, Menlo Park, CA (US); Dietrich Werner Vook, Los Altos, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/553,544

(22) Filed: Oct. 27, 2006

(51) Int. Cl. G06F 19/00; G01D 21/00

(52) U.S. Cl. 702/79; 702/1; 702/127; 702/57; 702/85; 702/107; 702/89

(57) ABSTRACT

Labeling asymmetric network cables for improved network clock synchronization. Time asymmetries between pairs in a network cable are identified and associated with individual cables. This time asymmetry information is used to improve clock synchronization according to the IEEE-1588 standard. The time asymmetry information may be stored in a database and associated with a serial number on the cable, or may be associated with the cable in human and/or machine readable form.

### TECHNICAL FIELD

Embodiments in accordance with the present invention relate to clock synchronization, and more particularly to IEEE-1588 clock synchronization.

### BACKGROUND

Present methods for synchronizing clocks over communications networks such as Network Time Protocol (NTP) and IEEE-1588 assume that transmission delays in the network are symmetric. That is, the delay in transmitting a packet from A to B is assumed to be equal to the delay in transmitting a packet from B to A. Particularly in the case of IEEE-1588, this assumption is needed in order to solve a system of linear equations for the delays between the various clocks in the network.

However, at fine time scales, this assumption is false. As an example, common twisted-pair cables used for Ethernet, such as those meeting the CATS standard (defined as ANSI-TIA-EIA-568-B) or CAT6 standard (ANSI-TIA-EIA-568-B.2-1) comprise four color-coded twisted copper wire pairs with RJ45 connectors. Typically, individual wires are 24 gauge copper, with pairs having approximately three twists per inch. The applicable standards specify parameters such as impedance, insertion loss, near end crosstalk and return loss. Since the cables are formed from twisted pairs, them is no guarantee that the electrical length of one twisted pair will be the same as the electrical length of another twisted pair in the same (standards compliant) cable. And when measured at the nanosecond and sub-nanosecond level, individual pairs in the same cable have different electrical lengths, and therefore introduce different delays in signal propagation.

### SUMMARY OF THE INVENTION

Asymmetries in transmission delays of individual network cables are measured and associated with the individual cable. Measured data may be associated with individual cables through use of serial numbers on the cable, human, machine, or electrically readable tags, or the like. Measured data may be used to improve performance of network clock synchronization system. Other parameters may be measured and associated with individual cables.

### BRIEF DESCRIPTION OF THE DRAWINGS

FIG. 1 shows a cable according to the present invention.

### DETAILED DESCRIPTION OF THE EMBODIMENTS

Current algorithms for clock synchronization in wired networks, such as IEEE-1588, (formally, IEEE 1588-2002, incorporated herein by reference) operate under the assumption that delays introduced by elements such as network cables are symmetric. That is, the delay introduced by a particular network cable in sending a packet from point A to point B is the same as the delay introduced by that network cable when a packet is sent from point B to point A. In an Ethernet network using 100BASE-TX standards to send data over CAT5 twisted pair cables, different pairs of the cable are used to send data in different directions. Even though cables may meet current standards (such as CAT5, CAT5E, and/or CAT6), the time delays introduced by differing electrical lengths of the different twisted pairs in the cable will probably not be the same. This asymmetry in time delays introduces errors into the clock synchronization process.

According to the present invention, parameters for individual cables are measured and associated with the individual cable. These parameters include propagation times in each direction. Advanced parameters could include transfer functions. Parameters such as the date and time testing was performed, and environmental parameters such as ambient temperature may also be measured and associated with the individual cable.

Measuring parameters such as propagation times may be performed by a number of methods. If measurements are performed during cable assembly where both ends of the cable may be attached to the same test device, delays, for example delays introduced by individual pairs in a multi twisted-pair cable such as a CAT5E cable, may be measured directly. It should be noted that once the propagation velocity of a cable is known or determined, electrical length may be translated to propagation time, and vice versa.

It should be noted that when speaking of propagation times in each direction with respect to commonly used network cables such as multi twisted pair cables, “each direction” refers to one or more twisted pairs used in the cable to send data in that particular direction. As an example, in 1000BASE-TX, two of the four twisted pairs are used, with one twisted pair being used to send data in each direction. Propagation times need not be taken by physically reversing the cable, but instead, may be taken by measuring the propagation times of each twisted pair.

In a field environment, as an example where cable is taken from a spool, cut to the needed length, and connectors applied, as would be the case in custom installations in buildings, time domain reflectometry (TDR) methods may be used to measure the electrical lengths of the individual twisted pairs in a multi twisted-pair cable.

While the propagation data, be it in terms of times, delta times from a reference pair, electrical lengths, or deltas in electrical lengths from a reference pair, the application, such as an implementation of the IEEE-1588 Precision Time Protocol (PTP) running on a device attached to the end of the cable must assign and interpret this propagation data.

Propagation data may be kept in a number of forms. As an example, in the case of a CAT5E cable comprising four twisted pairs, four numbers representing time delays may be kept, one for each pair. As an alternative, one pair may be used as a reference pair, and the differences from the reference pair recorded for the other pairs.

Once this propagation data has been obtained on an individual cable, according to the present invention, that data is associated with the cable.

One approach to associating the propagation data with an individual cable is to provide each individual cable with a serial number, and store the propagation data with the serial number in a computer database. Serial numbers may be provided in human, machine, and/or electrically readable fashion, at one or both ends of the cable.

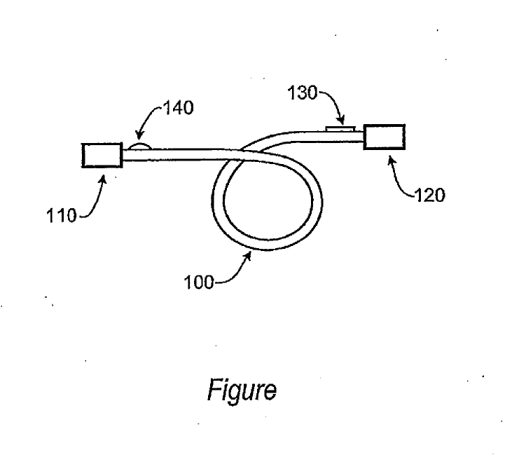

Referring to FIG. 1, Ethernet cable 100 has connector ends 110 and 120. A serial number may be placed on the RJ45 connectors 110 and/or 120 terminating each end of the cable. A tag containing serial number information may be attached to one end of the cable. Or, a tag containing serial number information, as an example a human-readable serial number and a bar code representing the same number may be applied to the cable 130, as an example, protected by clear heat-shrink tubing. The serial number information may be marked on the cable jacket.

The serial number may be provided in electrically readable form by placing an RFID tag on the cable. While tags and identifying information may be placed anywhere along the cable, utility suggests that they be placed near one or both of the connectors. An alternative approach is to provide an electrically readable serial number trough the use of a device such as the iButton manufactured by Maxi/Dallas Semiconductor of Sunnyvale, Calif.

The serial number may also be provided in electrically readable form readable through the cable itself. This may be done through providing a small network node 140 incorporated into the cable, or using other signaling means such as connecting the memory device between cable pairs. The IEEE 1451.4-2004 standard defines a method of communicating both normal data and metadata about sensors, defining a transducer electronic data sheet (TEDS), and a physical connection (MMI, or mixed-mode interface) for retrieving TEDS information, and may be applied here. Particularly, the template definition language (TDL) defined by the standard is applicable.

In a field environment such as where cables are assembled to length, the propagation data may be measured and associated with the port of the network equipment, such as a switch or router, to which the cable is connected.

The propagation data itself may be placed on the cable, in human, machine, and/or electrically readable form. Various printing and bar coding methods known to the art may be used to provide human and/or machine readable data.

In the case of providing propagation data in electrically readable form, a small programmable memory device such as the aforementioned iButton may be used, with the propagation data programed into the device memory. An RED tag programmed with the propagation data may be used. Other programmable memory devices may also be used. The programmable memory containing the propagation data may be incorporated into a small network node in the cable, so that the propagation data may be interrogated by the network element to which the cable is attached.

While identification and/or propagation information need be present only on one end of the cable, it may also be present on both ends of the cable.

According to the IEEE-1588-2002 standard, the Precision Time Protocol (PTP) states several assumptions which must be met to achieve optimal clock synchronization, among which is that network delay between a master and a slave on a subnet be symmetric (Section 6.1.3). Through use of the propagation data obtained through the use of the present invention, the asymmetry introduced by cabling may be corrected in solving the equations taught by the standard.

While the embodiments of the present invention have been illustrated in detail, it should be apparent that modifications and adaptations to these embodiments may occur to one skilled in the art without departing from the scope of the present invention as set forth in the following claims.

1. A method of identifying cable asymmetries comprising:
measuring the propagation time for a first portion of an individual cable to get a first propagation measurement,
measuring the propagation time for a second portion of the individual cable, which is different from the first portion, to get a second propagation measurement,
using the first propagation measurement and the second propagation measurement to form propagation data, and
associating the propagation data with the individual cable.

2. The method of claim 1 where the step of measuring the propagation time involves measuring the propagation time on different pairs in the cable.

3. The method of claim 1 where the step of measuring the propagation time involves measuring the electrical length of different pairs in the cable.

4. The method of claim 1 where the propagation data associated with the individual cable includes propagation times.

5. The method of claim 1 where propagation data associated with the individual cable includes electrical lengths.

6. The method of claim 1 where the propagation data associated with the individual cable includes the difference in propagation time for one direction on the individual cable with reference to the other direction.

7. The method of claim 1 where the propagation data associated with the individual cable includes the difference in electrical length for one pair in the individual cable with reference to another pair.

8. A method of identifying cable asymmetries comprising:
measuring the propagation time in two directions on an individual cable to get propagation data, and
associating the propagation data with the individual cable;
where the step of associating the propagation data with the individual cable further comprises:
associating a serial number with the individual cable, and
storing the serial number of the individual cable and the propagation data in a computer database.

9. The method of claim 8 where the serial number is present at both ends of the cable.

10. The method of claim 8 where the serial number is present at a single end of the cable.

11. The method of claim 8 where the serial number is at least one of human readable and machine readable.

12. (canceled)

13. The method of claim 8 where the serial number is electrically readable.

14. The method of claim 13 where the serial number is readable through radio frequency means.

15. The method of claim 13 where the serial number is readable through direct electrical connection.

16. The method of claim 13 where the serial number is readable through the cable.

17. A method of identifying cable asymmetries comprising:
measuring the propagation time in two directions on an individual cable to get propagation data, and
associating the propagation data with the individual cable:
where the step of associating the propagation data with the individual cable further comprises:
tagging the individual cable with the propagation data.

18. The method of claim 17 where the cable is tagged at one end.

19. The method of claim 17 where the cable is tagged at both ends.

20. The method of claim 17 where the propagation data on the individual cable is at least one of human readable and machine readable.

21. (canceled)

22. The method of claim 17 where the propagation data on the individual cable is electrically readable.

23. The method of claim 22 where the propagation data is readable through radio frequency means.

24. The method of claim 22 where the propagation data is readable through electrical contact.

25. The method of claim 22 where the propagation data is readable through the cable.

26. The method of claim 1 where the step of associating the propagation data with the individual cable further comprises:
associating the propagation data with a network port to which the cable is attached.

27. The method of claim 1 where the propagation data includes transfer functions for the individual cable.

28. The method of claim 1 further comprising:
using the propagation data associated with the individual cable to correct clock synchronization of devices passing signals over the cable.

29. The method of claim 28 where the clock synchronization is IEEE-1588 clock synchronization.

30. The method of claim 1 where the step of associating the propagation data with the individual cable further comprises:
associating a serial number with the individual cable, and
storing the serial number of the individual cable and the propagation data in a computer database.

31. The method of claim 1 where the step of associating the propagation data with the individual cable further comprises:
tagging the individual cable with the propagation data.
